(19) United States
(12) Patent Application Publication
(10) Pub. No.: US 2025/0183931 A1
(43) Pub. Date: Jun. 5, 2025

(54) METHOD AND DEVICE FOR DEMODULATING SIGNALS USING MULTIPLE RECEIVERS

(71) Applicant: Huawei Technologies Canada Co., Ltd., Kanata (CA)

(72) Inventors: Ke Wu, Montreal (CA); Seyed Ali Keivaan, Montreal (CA); Pascal Burasa, Cote Saint-Luc (CA)

(21) Appl. No.: 19/049,299

(22) Filed: Feb. 10, 2025

Related U.S. Application Data
(63) Continuation of application No. PCT/CA2022/051227, filed on Aug. 11, 2022.

(51) Int. Cl. H04B 1/16; H01Q 21/06; H04B 1/12

(52) U.S. Cl. CPC H04B 1/1615; H01Q 21/061; H04B 1/126

(57) ABSTRACT

A device includes one or more controllers and multiple spatially distributed receivers. Each receiver is controllable by the one or more controllers between an activated state in which the receiver is operable to detect an incoming signal, and a deactivated state in which the receiver is not operable to detect the incoming signal. At least a first receiver and a second receiver of the receivers, each in the activated state, are configured to demodulate the incoming signal by: demodulating with the first receiver an in-phase component of the incoming signal; and demodulating with the second receiver a quadrature component of the incoming signal.

### CROSS-REFERENCE TO RELATED APPLICATION

The present application is a continuation of Patent Cooperation Treaty Application Serial No. PCT/CA2022/051227, entitled “METHOD AND DEVICE FOR DEMODULATING SIGNALS USING MULTIPLE RECEIVERS,” filed on Aug. 11, 2022, the entirety of which is incorporated by reference herein.

### TECHNICAL FIELD

The present disclosure relates to the field of wireless communications, in particular to methods and devices for demodulating signals using multiple receivers.

### BACKGROUND

The fifth generation (5G) of wireless communications has in recent years been the subject of intense research in order to meet the ever-growing demands of data traffic, low latencies, and connectivity capabilities. One approach to meeting these requirements is the use of networks with multiple base stations and access points to enhance capacity and data throughput. However, for emerging multifunction wireless communication and sensing systems that operate at millimeter-wave (mmW) and terahertz (THz) frequencies, disruptive and innovative solutions are required to redefine the architectures of existing mmW and THz systems. The successful implementation of such architectures should be able to accommodate multi-functionality in a smart, dense, and efficient manner.

### SUMMARY

According to a first aspect of the disclosure, there is provided a device comprising: one or more controllers; and multiple spatially distributed receivers, each receiver being controllable by the one or more controllers between: an activated state in which the receiver is operable to detect an incoming signal; and a deactivated state in which the receiver is not operable to detect the incoming signal, and wherein at least a first receiver and a second receiver of the receivers, each in the activated state, are configured to demodulate the incoming signal by: demodulating with the first receiver an in-phase component of the incoming signal; and demodulating with the second receiver a quadrature component of the incoming signal. Therefore, the device may benefit from a multi-functional receiver topology that may provide adequate dynamic range without excessive power consumption.

The first receiver may be spaced from the second receiver such that a phase difference between waves of the incoming signal detected at the first receiver and waves of the incoming signal detected at the second receiver is π/2 radians. As a result, a quadrature amplitude modulated signal may be extracted from the incoming signal using a pair of receivers.

At least one of the first and second receivers, in the activated state, may be configured to determine a parameter of the incoming signal. The one or more controllers may be configured to transition, based on the parameter, at least a further one of the receivers from the deactivated state to the activated state. Therefore, additional receivers may be activated to in order to increase the signal-to-noise ratio of the QAM signal extracted from the incoming signal.

The one or more controllers may be further configured to transition, based on the parameter, at least one of the receivers from the activated state to deactivated state. As a result, the overall power consumption of the device may be reduced, by deactivating receivers that are not being used to contribute to the SNR of the QAM signal.

The one or more controllers may be configured to transition at least one receiver of the receivers: from the deactivated state to the activated state by enabling power to be delivered to the at least one receiver; and from the activated state to the deactivated state by preventing power from being delivered to the at least one receiver.

The receivers may be spatially distributed in a two-dimensional array or a in a three-dimensional array.

Each receiver may comprise an antenna operable to detect radio-frequency (RF) signals.

The parameter may be a polarization of waves of the incoming signal, an angle of arrival of the incoming signal, or a frequency of waves of the incoming signal. Therefore, the device may perform multiple functions by determining various parameters of incoming signals.

At least the first receiver, the second receiver, and a third receiver of the receivers, in the activated state, may be configured to determine an angle of arrival of the incoming signal, wherein a distance separating the first and second receivers is equal to a distance separating the second and third receivers.

The one or more controllers may be further configured to transition, based on the determined angle of arrival, the at least a further one of the receivers from the deactivated state to the activated state, wherein the at least a further one of the receivers is spaced from at least one of the first, second, and third receivers such that a phase difference between waves of the incoming signal detected at the at least a further one of the receivers and waves of the incoming signal detected at the at least one of the first, second, and third receivers corresponds to the determined angle of arrival. Therefore, the SNR of the QAM signal extracted from the incoming signal may be increased.

At least the first receiver, the second receiver, and a third receiver, a fourth receiver, a fifth receiver, and a sixth receiver of the receivers, in the activated state, may be configured to determine a two-dimensional angle of arrival of the incoming signal, wherein a distance separating the first and second receivers is equal to a distance separating the second and third receivers, wherein a distance separating the fourth and fifth receivers is equal to a distance separating the fifth and sixth receivers, and wherein the first, send, and third receivers define a first set of receivers that is oriented perpendicularly to a second set of receivers defined by the fourth, fifth, and sixth receivers.

The one or more controllers may be further configured to transition, based on the determined two-dimensional angle of arrival, the at least a further one of the receivers from the deactivated state to the activated state, wherein the at least a further one of the receivers is spaced from at least one of the first, second, and third receivers such that a phase difference between waves of the incoming signal detected at the at least a further one of the receivers and waves of the incoming signal detected at the at least one of the first, second, and third receivers corresponds to the determined two-dimensional angle of arrival. Therefore, the SNR of the QAM signal extracted from the incoming signal may be increased.

The at least one of the first and second receivers, in the activated state, may be configured to determine a polarization of waves of the incoming signal.

The one or more controllers may be further configured to transition, based on the determined polarization, at least a further one of the receivers from the deactivated state to the activated state, wherein the at least a further one of the receivers is configured to detect waves polarized in accordance with the determined polarization. Therefore, the SNR of the QAM signal extracted from the incoming signal may be increased.

The at least one of the first and second receivers may be configured to detect waves polarized according to a first polarization and a second polarization orthogonal to the first polarization. Therefore, by using a dual-polarized antenna, a single receiver may be used to determine the polarization rotation of any linearly polarized incoming signal.

At least the first receiver and the second receiver, in the activated state, may be configured to determine the polarization of the waves the incoming signal, wherein the first receiver is configured to detect waves polarized according to a first polarization, and wherein the second receiver is configured to detect waves polarized according to a second polarization orthogonal to the first polarization.

The at least one of the first and second receivers, in the activated state, may be configured to determine a frequency of waves of the incoming signal.

The one or more controllers may be further configured to transition, based on the determined frequency, at least a further one of the receivers from the deactivated state to the activated state, wherein the at least a further one of the receivers has a bandwidth corresponding to the determined frequency. Therefore, the SNR of the QAM signal extracted from the incoming signal may be increased.

According to a further aspect of the disclosure, there is provided a method demodulating an incoming signal using multiple spatially distributed receivers, wherein: each receiver is controllable by the one or more controllers between: an activated state in which the receiver is operable to detect the incoming signal; and a deactivated state in which the receiver is not operable to detect the incoming signal; and the method comprises: demodulating with a first receiver, in the activated state, an in-phase component of the incoming signal; and demodulating with a second receiver, in the activated state, a quadrature component of the incoming signal.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a schematic diagram of a virtual receiver matrix, according to an embodiment of the disclosure;

FIG. 2 is a schematic diagram of a unit cell or “half-receiver”, according to an embodiment of the disclosure;

FIG. 3 is a schematic diagram of three unit cells detecting an angle of arrival of an incident wave, according to an embodiment of the disclosure;

FIG. 4 is a schematic diagram of two unit cells detecting a polarization of an incident wave, according to an embodiment of the disclosure; and

FIG. 5 shows plots of in-phase and quadrature components of a detected incident wave, according to an embodiment of the disclosure.

### DETAILED DESCRIPTION

The present disclosure seeks to provide a novel, multi-functional receiver topology that may provide adequate dynamic range without excessive power consumption. While various embodiments of the disclosure are described below, the disclosure is not limited to these embodiments, and variations of these embodiments may well fall within the scope of the disclosure which is to be limited only by the appended claims.

In what follows, the term “unit cell”, “half-receiver”, or simply “receiver” refers to a single physical element of a matrix of receiving units, whereas the term “virtual receiver” refers to a “complete” receiver formed by the combination of two or more of such unit cells.

Generally, according to embodiments of the disclosure, there is described a matrix (or an array) of multiple spatially distributed receivers. Each receiver or “unit cell” is controllable by one or more controllers between an activated state in which the receiver is operable to detect an incoming signal, and a deactivated state in which the receiver is not operable to detect the incoming signal. Therefore, select receivers may be activated or deactivated in order to assist in detecting the incoming signal, or reducing the overall power consumption of the array, depending the requirements. Activating additional receivers to detect the incoming signal may improve the signal-to-noise ratio of the detected signal. When in the activated stated, each receiver is configured to demodulate an in-phase component or a quadrature component of an incoming signal. As a result, at least a first receiver and a second receiver, each in the activated state, may demodulate the incoming signal by demodulating, with one of the receivers, the in-phase component of the incoming signal, and by demodulating, with the other receiver, the quadrature component of the incoming signal. In order to demodulate both the in-phase and quadrature components of the incoming signal, the first and second receivers should be spaced such that the phase difference between waves of the incoming signal detected at each antenna of the first and second receiver should be 90°. As can be seen, since the outputs of two separate receivers may be required in order to demodulate both the in-phase and quadrature components of the incoming signal, each receiver/unit cell may effectively perform the function of a “half-receiver” (although throughout the disclosure the term “receiver” is used for simplicity, since each half-receiver performs a receiving function).

Accordingly, depending on the size of the matrix, a very large number of different virtual receivers may be implemented, by combining the outputs of two or more unit cells.

In addition, the virtual receiver matrix may be used to determine certain parameters of an incoming signal. For example, one or more of the receivers, when in the activated state, may detect a parameter of the incoming signal. Subsequently, based on the parameter, the one or more controllers may activate at least a further one of the receivers. For example, in response to determining the parameter of the incoming signal, the one or more controllers may selectively activate one or more other ones of the receivers in the matrix, these other receivers being suitable for detecting the incoming signal based on the determined parameter.

For instance, based on a number of receivers detecting the incoming signal as having a particular angle of arrival, the one or more controllers may activate other receivers whose antennas receive the incoming signal with a phase difference that corresponds to the determined angle of arrival. Meanwhile, activated receivers whose antennas receive the incoming signal with a phase difference that does not correspond to the determined angle of arrival may be deactivated, in order to reduce the overall power consumption of the matrix.

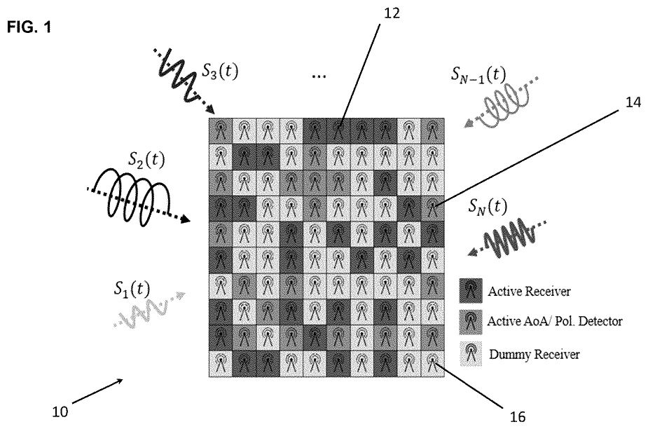

FIG. 1 shows an example of a two-dimensional matrix 10 of receivers forming a virtual receiver matrix. The virtual receiver is referred to as virtual in the sense that the receiver that is formed by combining the outputs of different unit cells is not fixed, but rather is floating in the two-dimensional matrix. In particular, the state of each unit cell (i.e. whether the unit cell is activated or deactivated) may dynamically change depending on one or more parameters of the incoming signal, such as the angle of arrival of the signal, the polarization of the signal, and the frequency of the signal.

In the context of FIG. 1, each complete “virtual” receiver may be formed by combining the outputs of multiple unit cells that are physically distributed across the matrix. As a result, a two-dimensional matrix of such virtual receivers may yield more degrees of freedom and may therefore be used to implement multiple functionalities and operations in a single receiver topology, while preserving low-power consumption, particularly in a large-array architecture.

Furthermore, since the data extracted from each unit cell is a baseband signal, the baseband signal may be simultaneously reused for different functions and data processing, which may in turn lead to more efficient power management.

The virtual receiver matrix leverages the phase difference between waves incident on two or more distinct unit cells in order to extract the quadrature amplitude modulated (QAM) signal based on the in-phase and quadrature components of the incoming signal. Any combination of two or more unit cells may be used to form a complete “virtual” receiver and, in this regard, the total number of possible virtual receivers is considerably increased when compared to conventional architectures.

Furthermore, the signal-to-noise ratio (SNR) can be significantly improved by using multiple unit cells spaced such that the phase difference between waves detected at each of the unit cells is equal to 90°. In other words, unit cells that detect the incident waves with a 90° phase shift relative to other cells that detect the incident waves may also be activated in order to improve the SNR. Accordingly, the virtual receiver matrix may be suitable for large-scale THz systems, particularly for compact range and line-of-sight applications in which the output power from each unit cell is relatively low compared to mmW and the RF spectrum.

Returning to FIG. 1, there are shown three example states for each receiver of matrix 10. In particular, a receiver may be a “dummy receiver” 16. Dummy receiver 16 is a receiver to which insufficient power (or no power) is being delivered such that dummy receiver 16 is incapable of detecting an incoming signal (schematically represented in FIG. 1 by S₁(t), S₂(t), S_{N-1}(t), and S_{N}(t)). Dummy receiver 16 may therefore be considered as being in a “deactivated” state. A receiver may alternatively be in an “active” state in which case it may either be an active receiver 12 or an active parameter detector 14 (e.g. an active angle of arrival/polarization detector). Each of active receiver 12 and active parameter detector 14 is a receiver to which sufficient power is being delivered such that active receiver 12 and active parameter detector 14 are capable of detecting an incoming signal.

In the case of active parameter detector 14, the receiver is being used to determine a parameter of an incoming signal (such as its angle of arrival, polarization, or frequency), as described in further detail below. In the case of active receiver 12, the receiver is being used to detect the incoming signal, and in particular the receiver is being used to extract an in-phase or a quadrature component of the incoming signal. At least two active receivers 12 may therefore be used to demodulate a QAM signal from the incoming signal (with one active receiver demodulating the in-phase component, and the other active receiver demodulating the quadrature component). Furthermore, more than two active receivers 12 may be used to detect the incoming signal and may thereby increase the SNR of the QAM signal.

Each receiver may be transitioned between the inactive state (i.e. from being a dummy receiver 16) and the active state (i.e. from being an active receiver 12 or an active parameter detector 14), using one or more controllers (not shown in FIG. 1).

As can be seen in FIG. 1, various incoming signals (SN (t)) with different angles of approach, polarizations, and frequencies may be incident on virtual receiver matrix 10. Virtual receiver matrix 10 inherits the advantages of linear interferences of a conventional multiport receiver. In particular, virtual receiver matrix 10 may use the phase difference between waves incident on two distinct unit cells of the array to demodulate the incoming signal. For example, each receiver within two-dimensional matrix 10 may demodulate either an in-phase component or a quadrature component of a received QAM signal, depending on the illumination angle. In order for the QAM signal to be completely demodulated, another unit cell with a phase shift of 90-degrees with respect to a first cell is required.

Therefore, in order to form a “complete” virtual receiver, there is needed at least a first unit cell configured to demodulate one of an in-phase component and a quadrature component of the incoming signal, and at least a second unit cell configured to demodulate the other of the in-phase component and the quadrature component. In other words, the first unit cell and the second unit cell are spaced from one another such that the phase difference between the waves detected at the first unit cell and the waves detected at the second unit cell is 90 degrees (or an integer multiple of 2π thereof). As also noted above, in order to increase the SNR, additional unit cells may also be activated, each additional unit cell being configured to demodulate either the in-phase component or the quadrature component of the incoming signal. In other words, each additional unit cell is spaced from the first unit cell or the second unit cell such that the phase difference between the waves detected at each additional unit cell and the waves detected at the first unit cell or the second unit cell is 90 degrees (or an integer multiple of 2π thereof).

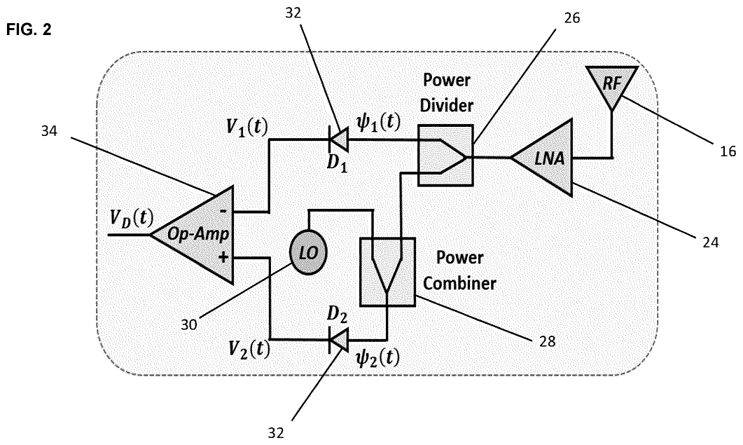

Turning to FIG. 2, there is shown an embodiment of a single unit cell that forms part of array 10. The unit cell comprises a radio-frequency antenna 22, a low-noise amplifier 24 connected to antenna 22, a power divider 26 connected to low-noise amplifier 24, a power combiner 28 connected to power divider 26, power detectors 32 connected to power divider 26 and power combiner 28, and an operational amplifier 34. A local oscillator signal 30 may be injected to the unit cell using power combiner 28. The phase difference between received signals at two distinct antennas in different unit cells of matrix 10 can be formulated as:

$$Δ ϕ = \frac{2 π}{λ} d cos ( AoA ) \qquad ( 1 )$$

where d is the inter-element distance between any two adjacent unit cells, λ is the wavelength, and AoA is the angle of arrival of the incident waves on the unit cells. Assuming that the normalized modulated signal within one unit cell at the output of low-noise amplifier 24 is S₁(t), the normalized modulated signal within another unit cell at the output of low-noise amplifier 24 is S₂(t), and the reference local oscillator signal is S_{L0}(t), then:

$${S}_{1} ( t ) = α ( t ) . a . {e}^{j ( 2 π {f}_{1} t + θ ( t ) )} \qquad ( 2 )$$

$${S}_{2} ( t ) = α ( t ) . a . {e}^{j ( 2 π {f}_{1} t + θ ( t ) )} . {e}^{- j Δ ϕ} \qquad ( 3 )$$

$${S}_{L O} ( t ) = a . {e}^{j ( 2 π {f}_{2} t )} \qquad ( 4 )$$

where α(t) and θ(t) are respectively the modulated amplitude and phase of the transmitted baseband signal, and e^{-jΔϕ} is the phase difference of the incoming signal between the two unit cells. In the case of a coherent receiver, the frequency of the carrier signal at both the transmitter and receiver is considered the same, and therefore f₁=f₂=f. The RF signal received at the first unit cell, after passing through power divider 26 and power combiner 28, can be obtained and denoted by ψ₁ and ψ₂ (as shown in FIG. 2), respectively.

$${ψ}_{1} ( t ) = \frac{a}{\sqrt{2}} . α ( t ) . {e}^{j ( 2 π f t + θ ( t ) )} \qquad ( 5 )$$

$${ψ}_{2} ( t ) = \frac{a}{\sqrt{2}} . α ( t ) . {e}^{j ( 2 π f t + θ ( t ) )} + \frac{a}{\sqrt{2}} {e}^{j 2 π f t} \qquad ( 6 )$$

These two signals are connected to power detectors 32 and result in baseband signals proportional to their RF power:

$$\begin{matrix}{V}_{i} ( t ) = K {\vert {ψ}_{i} ( t ) \vert}^{2} & i = 1 , 2\end{matrix} \qquad ( 7 )$$

where K is a constant, determined by the type of power detectors 32. Accordingly, the output voltages of power detectors 32 are described as follows

$${V}_{1} ( t ) = \frac{K {a}^{2}}{2} {α}^{2} ( t ) \qquad ( 8 )$$

$${V}_{2} ( t ) = \frac{K {a}^{2}}{2} [ 1 + {α}^{2} ( t ) + 2 α ( t ) cos θ ( t ) ] \qquad ( 9 )$$

If V₁(t) is subtracted from V₂(t) using a high-pass filter, a proportional voltage of the in-phase component can be extracted:

$${V}_{I} ( t ) = K {a}^{2} α ( t ) cos θ ( t ) \qquad ( 10 )$$

If the angle of arrival of incident waves is fixed to make the phase difference on other unit cells to be equal to

$$2 n π + \frac{π}{2} ,$$

where n=0, 1, 2, . . . , then the quadrature component of the QAM signal can be obtained. Using the same equations of (5) to (8) for the RF signal received at the second unit cell, S₂(t), the following voltage that is proportional to the quadrature component can be obtained:

$${V}_{Q} ( t ) = K {a}^{2} α ( t ) sin θ ( t ) \qquad ( 11 )$$

Now, considering a complex vector of Γ(t)=V₁(t)+jV_{Q}(t), the demodulated signal can be extracted.

An advantage of virtual receiver matrix 10 using “half-receivers” is the number of possible virtual receivers that can be implemented. Assuming a virtual receiver matrix of N by N half-receivers, the total number of possible virtual receivers that can be obtained using the combination of any two half-receivers out of N² elements is:

$$Total Number of Possible Virtual Receivers = ( \begin{matrix}{N}^{2} \\ 2\end{matrix} ) = \frac{{N}^{2} . ( {N}^{2} - 1 )}{2} \qquad ( 12 )$$

As described above, in order to improve the SNR of the demodulated QAM signal, additional unit cells may be activated based on one or more parameters of the incoming signal.

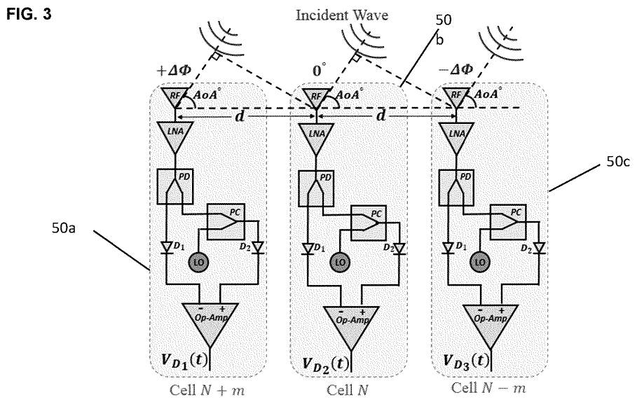

According to some embodiments, given an incoming signal with an unknown angle of arrival, three arbitrary unit cells 50a, 50b, 50c with equal inter-element distances may be used to determine the angle of arrival, as illustrated in FIG. 3 (with “PD” being short for power divider and “PC” short for power combiner). Given the equal inter-element distances between unit cells 50a, 50b, 50c, the phase differences between the signals received at each of unit cells 50a and 50c are equal, but with opposite signs with respect to unit cell 50b. The output voltages of the signals after having passed through the operational amplifiers can be expressed as

$${V}_{D 1} ( t ) = \frac{K {a}^{2}}{2} {α}^{2} ( t ) cos ( θ ( t ) - Δϕ ) \qquad ( 13 )$$

$${V}_{D 2} ( t ) = \frac{K {a}^{2}}{2} {α}^{2} ( t ) cos θ ( t ) \qquad ( 14 )$$

$${V}_{D 3} ( t ) = \frac{K {a}^{2}}{2} {α}^{2} ( t ) cos ( θ ( t ) + Δ ϕ ) \qquad ( 15 )$$

The angle of arrival can therefore be obtained using the following formula:

$$A o A = {cos}^{- 1} [ \frac{{λ}_{0}}{2 π d} {cos}^{- 1} ( \frac{{V}_{D 1} + {V}_{D 3}}{2 {V}_{D 2}} ) ] \qquad ( 16 )$$

Furthermore, using a two-dimensional array of unit cells, a two-dimensional angle of arrival may be determined, by using two sets of unit cells, perpendicularly disposed to one another, each set with at least three unit cells.

In response to determining the angle of arrival of the incoming signal, one or more additional receivers of the matrix may be activated. The activated receivers may be receivers whose antennas receive the incoming signal with a phase difference that corresponds to the determined angle of arrival. Therefore, the activated receivers may assist in increasing the SNR of the demodulated QAM signal. Receivers that are not suitable for detecting the incoming signal (e.g. whose antennas receive the incoming signal with a phase difference that does not correspond to the determined angle of arrival) may be deactivated, and therefore the power consumption of the array may be minimized.

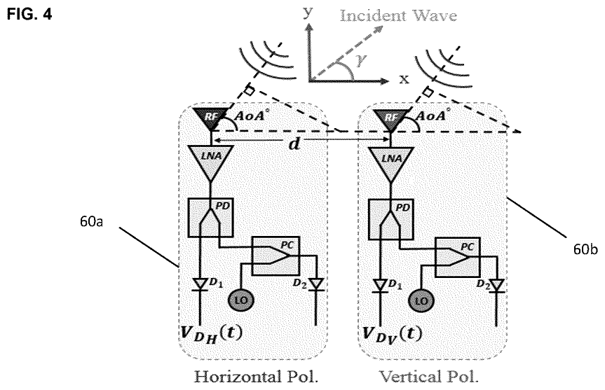

In addition to determining the angle of arrival of an incoming signal, matrix 10 may be used to determine a polarization of an incoming signal. In this case, using two distinct unit cells 60a and 60b with respective antennae that have a perpendicular linear polarization with respect to each other, the polarization rotation of any linearly polarized incoming signal may be determined, as shown in FIG. 4. In this regard, the polarization of an incident wave can be obtained by dividing the output signals of the power detectors for unit cells 60a and 60b with horizontally and vertically polarized antennae.

$${V}_{{D}_{H}} ( t ) = \frac{K {a}^{2}}{2} {α}^{2} ( t ) {cos}^{2} ( γ ) \qquad ( 17 )$$

$${V}_{{D}_{V}} ( t ) = \frac{K {a}^{2}}{2} {α}^{2} ( t ) {sin}^{2} ( γ ) \qquad ( 18 )$$

$$γ = {tan}^{- 1} [ \sqrt{\frac{{V}_{{D}_{V}}}{{V}_{{D}_{H}}}} ] \qquad ( 19 )$$

It should be noted that a single unit cell may be used to determine the polarization of the incoming signal if the antenna of the unit cell is dual-polarized and therefore able to detect the polarization rotation of any linearly polarized incoming signal.

In response to determining the polarization of the incoming signal, one or more additional receivers of the matrix may be activated. The activated receivers may be receivers whose antennae are configured to determine the determined polarization of the incoming signal. Therefore, the activated receivers may assist in increasing the SNR of the demodulated QAM signal. Receivers that are not suitable for detecting the incoming signal (e.g. whose antennae are not configured to detect waves according to the determined polarization of the incoming signal) may be deactivated, and therefore the power consumption of the matrix may be minimized.

Furthermore, since virtual receiver matrix 10 uses direct-conversion demodulation, any mismatch between the incoming RF and local oscillator frequencies will be reflected in the output of each unit cell, thereby enabling virtual receiver matrix 10 to determine the unknown frequency of an incoming signal.

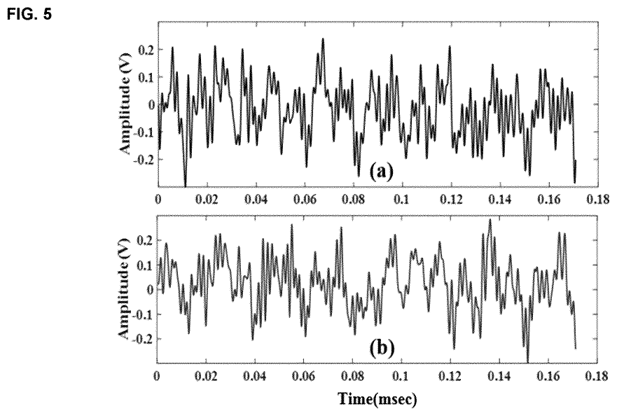

An embodiment of a virtual receiver matrix as described above was constructed based on 4×14 half-receivers designed and fabricated over Ka-band for 5G applications. The prototype was analyzed using the Advanced Design System (ADS) software platform and full-wave simulations were performed using electromagnetic field simulation software to design the antenna and power dividers/combiners. As explained above, each half-receiver included two power detectors for obtaining the QAM modulated signals. The output voltages of the power detectors were connected to an oscilloscope to demonstrate the in-phase and quadrature components of the demodulated signals. Using a vector signal generator, a bit train of 16-QAM modulation scheme with a symbol rate of 10 ksps was generated. The measured results for both in-phase and quadrature components of the demodulated signals, respectively, are shown in FIG. 5.

As will be recognized, a two-dimension matrix of virtual receivers, as described herein, may yield more degrees of freedom for implementing multiple functionalities and operations in a single receiver topology, such as angle of arrival detection, polarization detection, radar, sensing, and imaging. Furthermore, the virtual receiver matrix described herein is not limited to the schematic representations shown in the accompanying drawings. For example, each unit cell may be redesigned based on the design requirements of the matrix. For instance, instead of using two unit cells as a complete virtual receiver, the unit cells may be redesigned to form a virtual receiver from a combination of three or more unit cells. In this regard, the total number of possible virtual receivers would change accordingly.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A device comprising:
one or more controllers; and
multiple spatially distributed receivers, each receiver being controllable by the one or more controllers between:
an activated state in which the receiver is operable to detect an incoming signal; and
a deactivated state in which the receiver is not operable to detect the incoming signal, and
wherein at least a first receiver and a second receiver of the receivers, each in the activated state, are configured to demodulate the incoming signal by:
demodulating with the first receiver an in-phase component of the incoming signal; and
demodulating with the second receiver a quadrature component of the incoming signal.

2. The device of claim 1, wherein the first receiver is spaced from the second receiver such that a phase difference between waves of the incoming signal detected at the first receiver and waves of the incoming signal detected at the second receiver is π/2 radians.

3. The device of claim 1, wherein:
at least one of the first and second receivers, in the activated state, is configured to determine a parameter of the incoming signal; and
the one or more controllers are configured to transition, based on the parameter, at least a further one of the receivers from the deactivated state to the activated state.

4. The device of claim 3, wherein the one or more controllers are further configured to transition, based on the parameter, at least one of the receivers from the activated state to deactivated state.

5. The device of claim 4, wherein the one or more controllers are configured to transition at least one receiver of the receivers:
from the deactivated state to the activated state by enabling power to be delivered to the at least one receiver; and
from the activated state to the deactivated state by preventing power from being delivered to the at least one receiver.

6. The device of claim 5, wherein the receivers are spatially distributed in a two-dimensional array.

7. The device of claim 3, wherein:
at least the first receiver, the second receiver, and a third receiver of the receivers, in the activated state, are configured to determine an angle of arrival of the incoming signal, wherein a distance separating the first and second receivers is equal to a distance separating the second and third receivers.

8. The device of claim 3, wherein:
at least the first receiver, the second receiver, and a third receiver, a fourth receiver, a fifth receiver, and a sixth receiver of the receivers, in the activated state, are configured to determine a two-dimensional angle of arrival of the incoming signal, wherein a distance separating the first and second receivers is equal to a distance separating the second and third receivers, wherein a distance separating the fourth and fifth receivers is equal to a distance separating the fifth and sixth receivers, and wherein the first, send, and third receivers define a first set of receivers that is oriented perpendicularly to a second set of receivers defined by the fourth, fifth, and sixth receivers.

9. The device of claim 8, wherein the one or more controllers are further configured to transition, based on the determined two-dimensional angle of arrival, the at least a further one of the receivers from the deactivated state to the activated state, wherein the at least a further one of the receivers is spaced from at least one of the first, second, and third receivers such that a phase difference between waves of the incoming signal detected at the at least a further one of the receivers and waves of the incoming signal detected at the at least one of the first, second, and third receivers corresponds to the determined two-dimensional angle of arrival.

10. The device of claim 3, wherein:
the at least one of the first and second receivers, in the activated state, is configured to determine a polarization of waves of the incoming signal.

11. A method demodulating an incoming signal using multiple spatially distributed receivers, wherein:
each receiver is controllable by the one or more controllers between:
an activated state in which the receiver is operable to detect the incoming signal; and
a deactivated state in which the receiver is not operable to detect the incoming signal; and
the method comprises:
demodulating with a first receiver, in the activated state, an in-phase component of the incoming signal; and
demodulating with a second receiver, in the activated state, a quadrature component of the incoming signal.

12. The method of claim 11, wherein the first receiver is spaced from the second receiver such that a phase difference between waves of the incoming signal detected at the first receiver and waves of the incoming signal detected at the second receiver is π/2 radians.

13. The method of claim 11, further comprising:
determining, using at least one of the first and second receivers, a parameter of the incoming signal; and
transitioning, based on the parameter, at least a further one of the receivers from the deactivated state to the activated state.

14. The method of claim 13, further comprising transitioning, based on the parameter, at least one of the receivers from the activated state to deactivated state.

15. The method of claim 14, further comprising transitioning at least one receiver of the receivers:
from the deactivated state to the activated state by enabling power to be delivered to the at least one receiver; and
from the activated state to the deactivated state by preventing power from being delivered to the at least one receiver.

16. The method of claim 13, wherein the parameter is a polarization of waves of the incoming signal, an angle of arrival of the incoming signal, or a frequency of waves of the incoming signal.

17. The method of claim 13, wherein determining the parameter comprises:
determining, using at least the first receiver, the second receiver, and a third receiver of the receivers, an angle of arrival of the incoming signal.

18. The method of claim 17, wherein transitioning the at least a further one of the receivers comprises transitioning, based on the determined angle of arrival, the at least a further one of the receivers from the deactivated state to the activated state.

19. The method of claim 13, wherein determining the parameter comprises:
determining, using at least the first receiver, the second receiver, and a third receiver, a fourth receiver, a fifth receiver, and a sixth receiver of the receivers, a two-dimensional angle of arrival of the incoming signal.

20. The method of claim 13, wherein determining the parameter comprises:
determining, using the at least one of the first and second receivers, a polarization of waves of the incoming signal.
